(19) United States
(12) Patent Application Publication
(10) Pub. No.: US 2026/0039353 A1
(43) Pub. Date: Feb. 5, 2026

(54) SCALAR QUANTIZATION BASED CHANNEL STATE INFORMATION FEEDBACK MECHANISM

(71) Applicant: Huawei Technologies Co., Ltd., Shenzhen (CN)

(72) Inventors: Xiaoyan Bi, Shanghai (CN); Jianglei Ma, Ottawa (CA)

(21) Appl. No.: 19/326,372

(22) Filed: Sep. 11, 2025

Related U.S. Application Data
(63) Continuation of application No. PCT/CN2023/115374, filed on Aug. 29, 2023.
(60) Provisional application No. 63/453,007, filed on Mar. 17, 2023.

(51) Int. Cl. H04B 7/06; H04B 7/0456; H04L 5/00

(52) U.S. Cl. CPC H04B 7/0626; H04B 7/0456; H04L 5/0051

(57) ABSTRACT

According to an aspect of the disclosure there is provided a method, in an apparatus, the method including: for each at least a subset of channel estimates, obtain a respective quantized channel estimate by quantizing the channel estimate using scalar quantization; wherein the channel estimates are obtained on channel state information reference symbols (CSI-RS) transmitted on a plurality of transmit antenna ports; and transmitting channel state information (CSI) based on the quantized channel estimates.

### CROSS-REFERENCE TO RELATED APPLICATIONS

This application is a continuation of International Application No. PCT/CN2023/115374, filed on Aug. 29, 2023, which claims priority to and the benefit of U.S. Provisional Application No. 63/453,007 filed in the U.S. Patent and Trademark Office on Mar. 17, 2023. All of the aforementioned patent applications are hereby incorporated by reference in their entireties.

### TECHNICAL FIELD

The application relates generally to wireless telecommunications, and more specially to systems and methods of transmitting and receiving channel state information (CSI), and to methods of configurating the transmission of CSI.

### BACKGROUND

In accordance with the New Radio (NR) standard, the mechanism of CSI feedback has been modified on several occasions with subsequent releases. For example, R15 specified a type I/II codebook, R16 specified a type II t-f compression, R17 specified a reciprocity-based codebook, and R18 specified a codebook specifically designed for mobility.

It is a significant standardization effort for each release, involving a new chipset implementation effort for every codebook enhancement.

6G networks have a diverse set of implementation scenarios, including diverse frequency bands, transceiver architectures, e.g. hybrid beamforming (HBF) and/or digital beamforming (DBF), and multiple antenna array options, such as uniform or non-uniform antenna arrays, 2-dimensional or 3-dimensional antenna arrays.

For example, carrier frequency ranges may include sub-3 GHz, C-band, 6˜15 GHz (cmWave), mmWave and sub-THz. The transceiver architecture at a gNB may be:
for sub-3 GHz: Full digital RF
for C-band, 6˜15 GHz: Full digital RF for horizontal antenna elements, hybrid (analog+digital RF) for vertical antenna elements;
for mmWave and sub-THz: HBF
   the antenna array may for example be a uniform or non-uniform antenna panel, or a 2-dimensional or 3-dimensional antenna aperture.

The number of antenna ports may at 2\hat{ }n, for some value of n, or there may be a more general constraint that the number of antenna ports N be less than or equal to some number M of supported antenna ports.

CSI transmission can take place in these diverse contexts, and for diverse scenarios that include CSI for diverse narrowband vs. wideband, high/medium/low velocity use equipment (UE).

### SUMMARY

According to an aspect of the disclosure there is provided a method including: for each at least a subset of channel estimates, obtaining a respective quantized channel estimate by quantizing the channel estimate using scalar quantization; wherein the channel estimates are obtained on channel state information reference symbols (CSI-RS) transmitted on a plurality of transmit antenna ports; and transmitting channel state information (CSI) based on the quantized channel estimates.

In some embodiments, the method further includes performing compression of the quantized channel estimates to produce compressed quantized channel estimates, wherein transmitting channel state information (CSI) based on the quantized channel estimates comprises transmitting the compressed quantized channel estimates.

In some embodiments, the method further includes receiving a first signaling; when the first signaling indicates to perform scalar quantization on channel estimates, performing said steps of for each at least a subset of the channel estimates, obtaining a respective quantized channel estimate by quantizing the channel estimate using scalar quantization and transmitting channel state information (CSI) based on the quantized channel estimates.

In some embodiments, the method further includes: receiving a second signaling; when the second signaling indicates to use vector quantization on channel estimates; and transmitting CSI feedback using the vector quantization.

In some embodiments, the method further includes: receiving signaling indicating a quantization accuracy to be applied to all channel estimates; and performing the quantization using the indicated quantization accuracy.

In some embodiments, the method further includes receiving signaling indicating a respective quantization accuracy to be applied respective channel estimates; and performing quantization of the respective channel estimates using the respective quantization accuracy.

In some embodiments, each quantization accuracy comprises an indication of a first number of bits for amplitude and an indication of a second number for phase.

In some embodiments, the method further includes selecting the subset of channel estimates to feedback; and transmitting an indication of the selected subset of channel estimates that are being fed back.

In some embodiments, selecting the subset of channel estimate to feedback comprises applying a threshold based on a strongest channel estimate.

In some embodiments, wherein said at least a subset of channel estimates includes all of the channel estimates.

In some embodiments, the method further includes receiving signaling indicating a configuration of the transmitted CSI-RS.

According to an aspect of the disclosure, there is provided an apparatus including a processor and a computer readable storage medium having stored thereon computer executable instructions. The computer executable instructions, when executed by the processor, cause the apparatus to: for each at least a subset of channel estimates, obtain a respective quantized channel estimate by quantizing the channel estimate using scalar quantization; wherein the channel estimates are obtained on CSI-RS transmitted on a plurality of transmit antenna ports; and transmit CSI based on the quantized channel estimates.

In some embodiments, the computer executable instructions further include computer executable instructions that, when executed by the processor, cause the apparatus to perform a method as described above.

According to an aspect of the disclosure, there is provided a method including: receiving channel state information (CSI), wherein the CSI is transmitted based on quantized channel estimates; wherein, for each at least a subset of channel estimates, a respective quantized channel estimate is obtained by quantizing the channel estimate using scalar quantization; wherein the channel estimates are obtained on CSI reference symbols (CSI-RS) transmitted on a plurality of transmit antenna ports.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

Embodiments of the disclosure will now be described with reference to the attached drawings in which:

FIG. 1 is a block diagram of a communication system.

FIG. 2 is a block diagram of a communication system.

FIG. 3 is a block diagram of a communication system showing a basic component structure of an electronic device (ED) and a base station.

FIG. 4 is a block diagram of modules that may be used to implement or perform one or more of the steps of embodiments of the application.

FIG. 5A depicts a framework for CSI reporting.

FIG. 5B depicts UE functional blocks for CSI reporting using scalar quantization.

FIGS. 6A and 6B show examples of sparse CSI-RS.

FIG. 7 is a flowchart of a method CSI-RS reporting.

FIG. 8 is a detailed example of channel estimation.

FIG. 9 depicts a set of quantized channel estimates produced from the example of FIG. 8.

FIG. 10 illustrates examples of spatial, frequency and time domains that may be used for CSI-RS transmission to which vector quantization may be applied in accordance with embodiments of the present disclosure.

FIG. 11 illustrates an example of a uniform planar antenna array that may be used for transmissions of reference signals for CSI that are being processed according to embodiments of the present application.

FIG. 12 illustrates an example of a three-dimensional antenna array that may be used for transmissions of reference signals for CSI that are being processed according to embodiments of the present application.

FIG. 13 illustrates an example of a chirp signal that may be used as a reference signal for determining CSI according to embodiments of the present application.

FIG. 14 illustrates an example of chirp beam basis matrix for UE in near-field antenna according to embodiments of the present application.

FIG. 15 illustrates an example of a basis matrix, in which a sub-set portion of the basis matrix is indicated to be configured, according to embodiments of the present application.

FIG. 16 illustrates an example of an equation for determining a basis matrix with oversampling according to embodiments of the present application.

FIG. 17 depicts a framework for CSI reporting.

FIG. 18 is a signal flow diagram for signaling between a UE and a base station (BS), in accordance with embodiments of the present disclosure.

FIG. 19 is an example of a coordinate transform.

### DETAILED DESCRIPTION

Embodiments of the disclosure provide a unified and configurable CSI feedback mechanism that is suitable, for example, for 6G MIMO. The new CSI feedback mechanism includes a feedback mechanism based on scalar quantization.

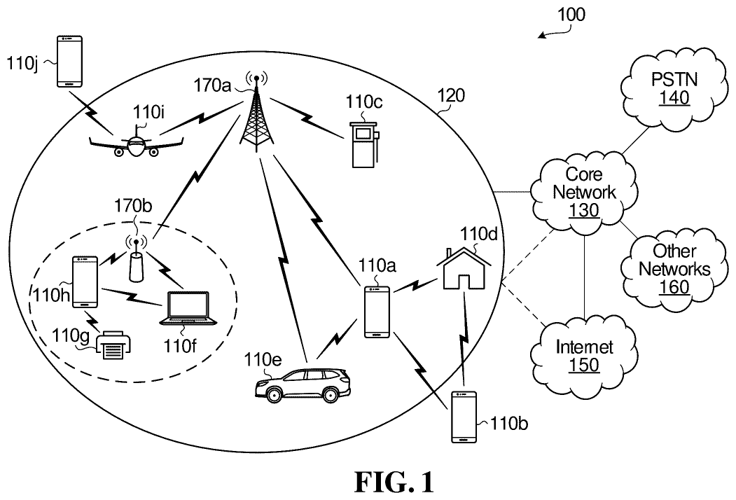

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

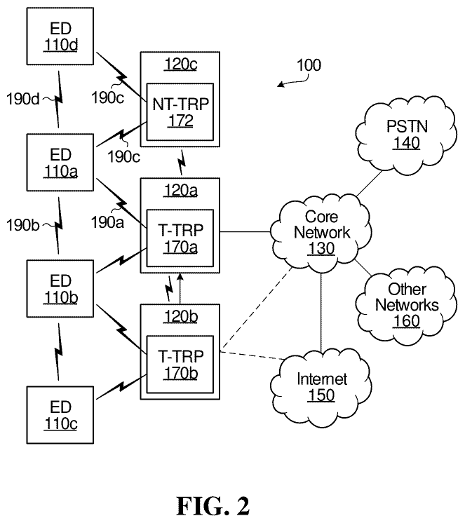

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs, e.g. gNBs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some, or all, of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

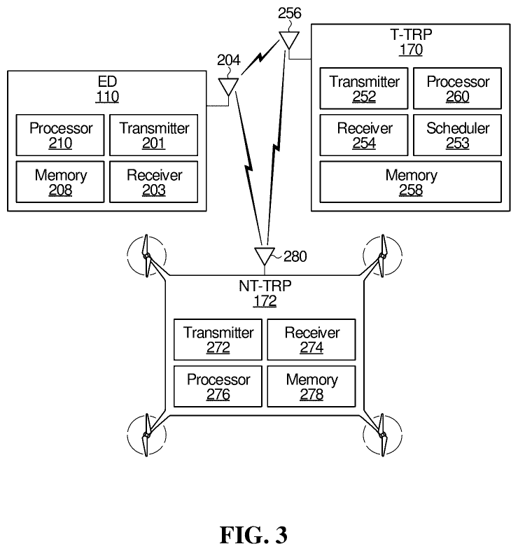

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

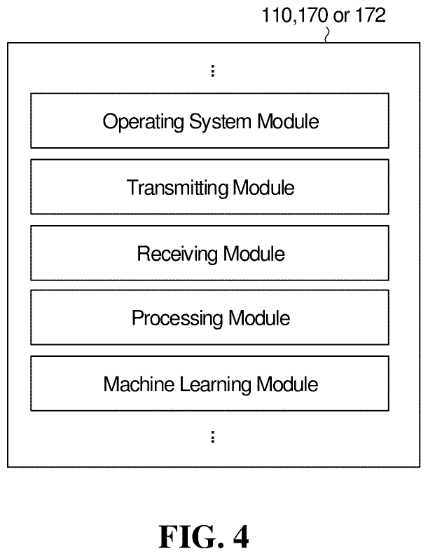

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

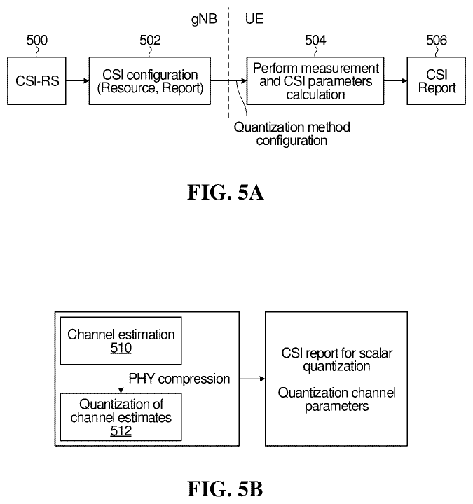

An overall CSI feedback framework is shown in FIG. 5A. This framework may, for example, be implemented using the system of FIGS. 1 to 4. CSI-RS transmission is generally indicated at 500. CSI feedback configuration is generally indicated at 502. A gNB implements 500 and 502. UE side functionality includes CSI measurement generally indicated at 504, and CSI reporting, generally indicated at 506.

### CSI-RS Transmission

CSI-RS are transmitted using transmit antenna ports. Transmission using an antenna port involves transmitting known reference symbols using one or more specified antennas, and one or more OFDM subcarriers.

### CSI Configuration

CSI configuration involves the transmission of signaling from the gNB to the UE to inform the UE of the nature of CSI-RS transmission (e.g. CSI RS port configuration) and/or to inform the UE how to report CSI. In some embodiments, multiple feedback mechanisms are available for use by a UE, one of which is the provided method of feedback based on scalar quantization. In some embodiments, CSI configuration includes the gNB sending an indication of which feedback mechanism to use, as between the provided method based on scalar quantization and one or other methods. Application scenarios for use of feedback based on scalar quantization include, for example but are not limited to, sensing assisted channel acquisition, AI assisted channel acquisition.

### CSI Measurement

CSI measurement at the UE, also referred to as channel estimation, involves, on a per receive antenna basis, estimating CSI (e.g. amplitude and phase) on a per transmit antenna port basis. A full set of channel estimates includes one estimate for each transmit antenna port, receive antenna pair. A UE conducts CSI estimation on the resources for the configured CSI-RS to obtain the estimates of the channel between gNB and UE.

### CSI Reporting

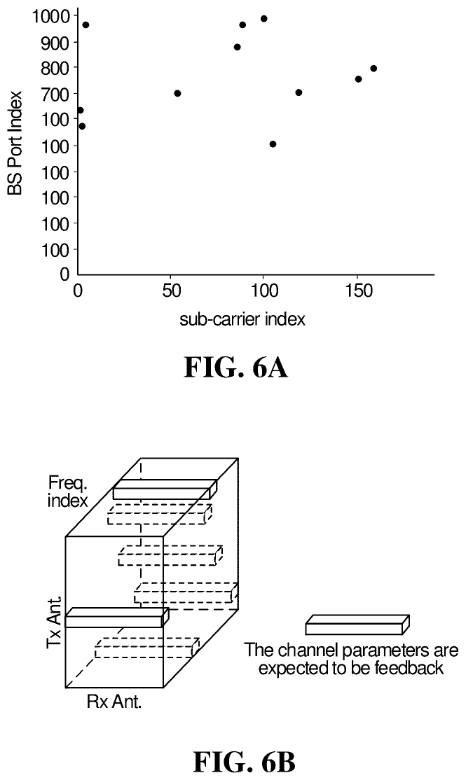

CSI reporting, also referred to as CSI feedback, involves transmission from the UE to the gNB information based on the CSI estimates. In some embodiments, multiple feedback mechanisms are available for use by a UE, one of which is the provided method of feedback based on scalar quantization. In some embodiments, the gNB sends an indication of which feedback mechanism to use, as between the provided method based on scalar quantization and one or other methods. Another one of the available mechanisms may, for example, be one of the existing codebook-based mechanisms. Which feedback mechanism a given UE is to use may be set based on explicit or implicit signaling from the base station, or alternatively can be set based on other conditions. For example, in one embodiment, a UE selects which feedback scheme to use based one or more of the following:
antenna structure transparency to the UE, meaning whether or not the UE is unaware of the antenna deployment scenario;
sparsity of RS transmission; for example, for ultra-sparse reference symbol (RS) transmission—when the sparsity is sufficiently sparse (for example as defined by some metric and associated threshold), the feedback based on scalar quantization may be used; an example of a CSI-RS transmission that is sparse is shown in FIG. 6A where it can be seen that as among possible locations in the frequency, transmit antenna dimensions, CSI-RS is transmitted on only a small number of these possible locations; another example is shown in FIG. 6B;
whether or not RS is beamformed;
for example, for beamformed RS, use scalar quantization;
UE capability; since the feedback based on scalar quantization may be relatively less complex compared to other mechanisms, it may be suitable for UEs with lower capability to use such a mechanism. For example, code book based approaches may involve the use of computationally intensive matrix calculation, including matrix decomposition, matrix multiplication etc. that are not needed for the scalar quantization-based approach.

In the provided approach based on scalar quantization, a set of channel estimates per se (after quantization, and possibly also after compression) is fed back. This is relatively simple, compared to a codebook-based approach in which channel estimate vectors are projected into a codebook matrix and then quantized. This approach is particularly suitable for CSI feedback, that is measured in a non-continuous block, e.g. based on ultra-sparse reference signal in time/frequency/space domain.

An example of UE functionality is shown in FIG. 5B. Shown are a channel estimation block 510 and a quantization block 512. The quantization block 512 performs scalar quantization in accordance with the method described herein. CSI reporting takes place based on the output of scalar quantization.

### Method of CSI Reporting Using on Scalar Quantization

In this embodiment, the UE directly quantizes the complex numbers of the channel estimation of CSI-RS and then feeds back some or all of these quantized values to the gNB. Optionally, the quantized data is also compressed based on a configured compression scheme, and the compressed quantized values are fed back to the gNB. Compression schemes include transform, entropy coding, etc. The transform may be a fast Fourier transform (FFT), inverse fast Fourier transform (IFFT), discrete cosine transform (DCT), or wavelet transform. Entropy coding may include arithmetic coding, Huffman coding, or run length coding.

In some embodiments, each channel estimate has a respective index. The index for a given channel estimate is associated with the receive antenna and the transmit antenna port. In some embodiments, all of the channel estimates are fed back. In some embodiments, only a subset of the channel estimates are fed back, and to indicate which channel estimates are being fed back, the UE also transmits a set of indices to the gNB to identify them. A specific example is described below where channel estimates to feedback are selected based on relative channel strength.

In embodiments that include compression, an order of aggregating channel estimates to conduct compression may be specified.

Quantization accuracy of the channel estimates for CSI feedback may be configured in signaling from the gNB. This can, for example, configure a number of bits for quantization of the estimates by the UE. Alternatively, or in addition, quantization accuracy could be associated with number of configured RS resource.

In some embodiments, all channel estimates are quantized with a common quantization accuracy. Alternatively, the quantization accuracy can be different for different channel estimates. For example, a higher accuracy may be used for important estimates. In some embodiments, differential quantization for the channel estimates is employed. In some embodiments, quantization accuracy is specified separately for amplitude and phase. For example, (3,4) bits can mean quantization using 3 bits for amplitude, and 4 bits for phase.

In some embodiments, a criteria, such as a threshold, is used to select which channel estimates to feedback. In a specific example, for a given channel estimate Cᵢ, the channel estimate is fed back if the following is true:

$$log 10 ( \frac{{C}_{i}}{{C}_{ma x}} ) > 10 dB$$

where Cₘₐₓ is the maximum of all the channel estimates. Of course other threshold values, and other equations or criteria can be used.

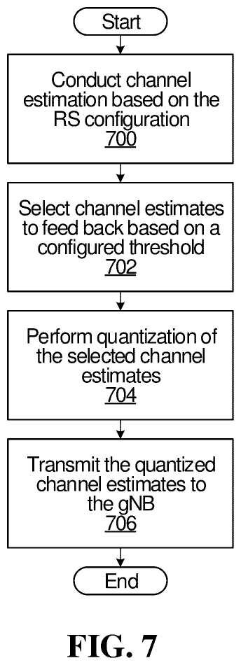

A specific example of a UE behavior is shown in the flowchart of FIG. 7. At 700, the UE conducts channel estimation based on the RS configuration. At 702, the UE selects the channel estimates to feedback based on a configured threshold. At 704, the UE perform quantization of the selected channel estimates. At 706, the UE transmits the quantized channel estimates to the gNB. The UE also sends indices of the selected channel estimates. These can be sent together with the channel estimates, or separately.

In some embodiments, the UE transmits a capability report that a number of transmit antenna ports. The indicated number of antenna ports acts a threshold for the base station to decide between instructing the UE to use the provided scalar quantization method of channel feedback vs. a more complex method. This approach is suitable for situations where the UE may not have the computational capabilities to perform the more complex method for larger numbers of antennas; for example, it may not be able to perform matrix calculations above a certain size. For example, the UE may send a capability report indicating 16 transmit antenna port capability. Then a gNB with 128 antenna ports >16, will configure the UE to use the scalar quantization method.

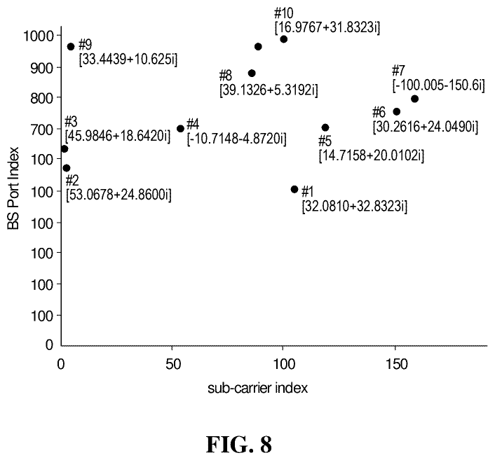

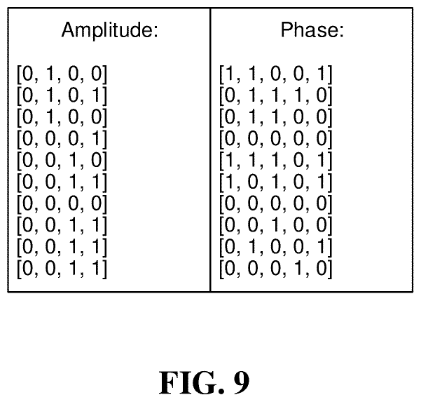

A detailed example is shown in FIGS. 8 and 9. FIG. 8 shows a set of channel estimates for the sparse pattern of FIG. 6A. To select the channel estimates to feed back the sequence is normalized to the maximum amplitude value. In the illustrated example, the maximum amplitude=180.77986620472976. The normalized sequenced is:
The normalized amplitudes are: 0.25392, 0.32416, 0.27448, 0.065109, 0.1374, 0.21382, 1, 0.21846, 0.19411, 0.19956.
Perform quantization with 4 bits for amplitude: 0.281250, 0.343750, 0.281250, 0.093750, 0.156250, 0.218750, 0.968750, 0.218750, 0.218750, 0.218750;
Transfer them to bits: 0100, 0101, 0100, 0010, 0011, 0100, 1111, 0100, 0100, 0100.
Perform Huffman coding to compress the data into: 101110101111110001101000.
The normalized phases are: 0.79697, 0.4381, 0.38515, −2.7148, 0.9367, 0.6715, −2.157, 0.1351, 0.30761, 1.0808.
Perform quantization with 5 bits for amplitude: 11111001011011101001100010001.

For this specific example, 4-bit quantization is performed on the amplitude and 5-bit quantization is performed on the phase. The quantized values are shown in FIG. 9. In an implementation where not all of the channel estimates are fed back, a selection criteria is applied (for example the above-described relative amplitude criteria) to select the channel estimates to feed back. Then, quantized versions of the selected channel estimates are fed back together with indices. In the above example, where there are 10 channel estimates, these can be given indices 0 to 9.

An overall CSI feedback framework is shown in FIG. 17. This framework may, for example, be implemented using the system of FIGS. 1 to 4. CSI-RS transmission is generally indicated at 1700. CSI feedback configuration is generally indicated at 1702. A gNB implements 1700 and 1702. UE side functionality includes CSI measurement generally indicated at 1704, and CSI reporting, generally indicated at 1706.

### CSI-RS Transmission

CSI-RS are transmitted using transmit antenna ports. Transmission using an antenna port involves transmitting known reference symbols using one or more specified antennas, and one or more OFDM subcarriers.

### CSI Configuration

CSI configuration involves the transmission of signaling from the gNB to the UE to inform the UE of the nature of CSI-RS transmission (e.g. CSI RS port configuration) and/or to inform the UE how to report CSI. In some embodiments, multiple feedback mechanisms are available for use by a UE, one of which is the provided method of feedback based on scalar quantization. In some embodiments, CSI configuration includes the gNB sending an indication of which feedback mechanism to use, as between the provided method based on scalar quantization and one or other methods. Application scenarios for use of feedback based on scalar quantization include, for example but are not limited to, sensing assisted channel acquisition, artificial intelligence (AI) assisted channel acquisition.

### CSI Measurement

CSI measurement at the UE, also referred to as channel estimation, involves, on a per receive antenna basis, estimating CSI (e.g. amplitude and phase) on a per transmit antenna port basis. A full set of channel estimates includes one estimate for each transmit antenna port, receive antenna pair. A UE conducts CSI estimation on the resources for the configured CSI-RS to obtain the estimates of the channel between gNB and UE.

### CSI Reporting

CSI reporting, also referred to as CSI feedback, involves transmission from the UE to the gNB information based on the CSI estimates. In some embodiments, multiple feedback mechanisms are available for use by a UE, one of which is the provided method of feedback based on scalar quantization. In some embodiments, the gNB sends an indication of which feedback mechanism to use, as between the provided method based on scalar quantization and one or other methods. Another one of the available mechanisms may, for example, be one of the existing codebook-based mechanisms. Which feedback mechanism a given UE is to use may be set based on explicit or implicit signaling from the base station, or alternatively can be set based on other conditions.

Determining an estimate of a channel between a transmitter and a receiver, for example a base station and a UE, involved transmitting a reference signal by the transmitter and the receiver receiving the reference signal. The receiver measures the received reference signal and determines how the known reference signal has changed and that change is attributed to the effects of the channel.

Vector quantization is also referred to as “block quantization” or “pattern matching quantization” and may be used for lossy data compression. Values from a multidimensional vector space are encoded into a finite set of values from a discrete subspace of a lower dimension. A lower dimension space vector may use less storage space, so the data is therefore compressed. Vector quantization may be performed by projection or by using a codebook.

A set of discrete amplitude levels is quantized jointly rather than each sample being quantized separately. Consider a k-dimensional vector [x₁, x₂ . . . xₖ] of amplitude levels. It is compressed by choosing a nearest matching vector from a set of n-dimensional vectors [y₁, y₂, . . . y], with n<k. All possible combinations of the n-dimensional vector [y₁, y₂, . . . yₖ] form the vector space to which all the quantized vectors belong.

In some situations, only an index of the codeword in the codebook is sent instead of the quantized values. This conserves space and achieves more compression.

In some embodiments, a representation of the channel H that is subject to vector quantization is expressed as a matrix or tensor:

$$ℋ = C \times {}_{1} {B}_{T} \times {}_{2} {B}_{F} \times {}_{3} {B}_{S}$$

where B_{T}, B_{F}, and B_{S} are basis matrices in the time domain, frequency domain and spatial domain, respectively. C is a matrix that includes channel parameters that are fed back to the transmitter.

When the antenna array at the transmitter is a uniform planar antenna array, the basis matrix in the spatial domain B_{S} may be a two-dimensional discrete Fourier transform (2D-DFT)

When the antenna array at the transmitter is a non-uniform planar antenna array, the basis matrix in the spatial domain B_{S} may be represented in the form:

$${B}_{S} = A \cdot {B}_{DFT}$$

where matrix A may be related to a shape of the non-uniform antenna array.

In some embodiments, the matrix A may be configured for the receiver by broadcast or multicast signaling by the network. In some embodiments, the matrix B_{DFT} may be predefined, for example in a telecommunication standard.

In some embodiments, when the basis matrix in the time domain B_{T} is configured as the identity matrix, only spatial and frequency domain vector quantization is applied and the channel matrix or tensor H may be represented as:

$$H = {B}_{S} \cdot C \cdot {B}_{F} or H = {B}_{S} ⊗ {B}_{F} \cdot C$$

When the time and frequency domain basis matrices B_{T} and B_{F} are each configured as the identity matrix, only spatial domain vector quantization is applied, and the channel matrix or tensor H may be represented as:

$$H = {B}_{S} \cdot C$$

In some embodiments, the basis matrix in time domain, frequency domain and spatial domain may be configured independently. For example, the base station may transmit configuration information to the UE that enables the UE to configure the UE to use an appropriate time domain basis matrix, frequency domain basis matrix, or spatial domain basis matrix. Furthermore, the configuration may be used to modify or update a time domain basis matrix, frequency domain basis matrix, or spatial domain basis matrix that was previously configured.

In some embodiments, a basis matrix or tensor may be Kronecker product of the configured basis matrixes for two or more domains.

In some embodiments, the basis matrix in one or more of the time domain, frequency domain, or spatial domain may be predefined, for example in a telecommunication standard. In some embodiments, the basis matrix in one or more of the time domain, frequency domain, or spatial domain may be notified by the base station as part of configuration information sent to the UE. Examples of predefined basis matrix may include the identity matrix, DFT matrix, chirp matrix.

In some embodiments, the number of domains (selected from space, time, frequency) for which vector projection may be configured by the base station. For example, the number of domains may be part of configuration information sent by the base station.

In some embodiments, the number of domains (selected from space, time, frequency) for which vector projection may be associated with the reference signal (RS) configured for CSI measurement. The type of RS may be a CSI-RS, or other types of RS capable of being used for determining CSI.

Vector quantization is suitable for determining CSI feedback over one or more domains. Measurements for determining CSI are made of the reference signal, wherein the reference signal is measured in a at least one of a continuous time window or block, a continuous frequency window or block or a continuous spatial window or block. In some embodiments, with regard to the spatial domain, the receiver determining CSI for the purposes of CSI feedback may be aware of the antenna array structure. With regard to the frequency domain, the receiver determining CSI for the purposes of CSI feedback may receive the reference signal over a continuous frequency band. With regard to the time domain, the receiver determining CSI for the purposes of CSI feedback may receive the reference signal over a continuous frequency band time window.

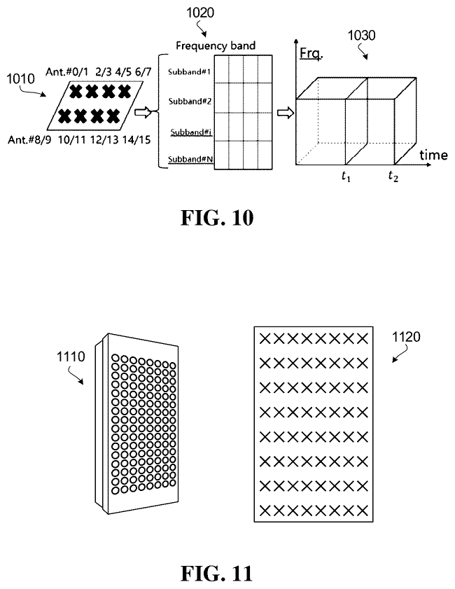

FIG. 10 illustrates an example of an antenna array 1010 in the spatial domain where each “X” on the 2D antenna array represents a pair of antennas for transmitting a reference signal to be used for CSI measurement and feedback, an example of a frequency domain resource 1020 where multiple sub-bands are shown for transmitting a reference signal to be used for CSI measurement and feedback, and an example of a time domain resource 1030 to be used for transmitting a reference signal to be used for CSI measurement and feedback.

In order to determine CSI, the receiver measures channel information in one or more of the time domain, the frequency domain, or the spatial domain. The receiver may determine feedback to send to the transmitter in form of a channel matrix or tensor. The receiver may feedback all eigen vectors of the channel matrix or tensor or a subset of eigen vectors of the channel matrix or tensor.

In some embodiments, the receiver may also feedback a precoding matrix to be used at the UE sides that the UE has selected or that the UE is recommending be used.

Information about antenna arrays is particularly relevant to basis matrix in the spatial domain. Examples of different types of antennas for which information about the antenna may affect the basis matrix in the spatial domain include a 2D antenna array and a 3D antenna array. FIG. 11 illustrates an example of a 2D planar antenna array 1110. The arrangement of antennas is also shown in the 2D arrangement 1120. In some embodiments, for a uniform planar array, the basis matrix in the spatial domain may be represented as:

$${B}_{S} = {B}_{DFT}$$

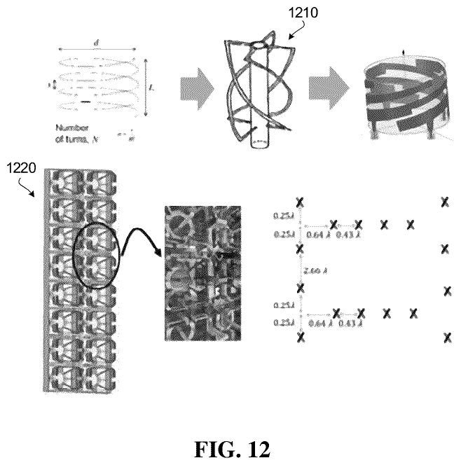

FIG. 12 illustrates an example of an individual 3D antenna 1210 and an antenna array 1220 made up of multiple individual 3D antennas. In some embodiments, for a uniform planar array, the basis matrix in the spatial domain may be represented as:

$${B}_{S} = A \cdot {B}_{DFT}$$

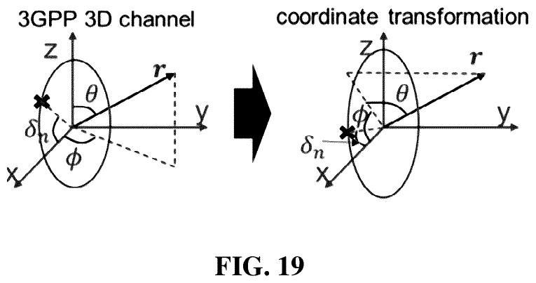

FIG. 19 shows a coordinate transform. In a polar coordinate system, a direction vector unit can be represented as

$$r = [ \begin{matrix}cos θ cos ϕ \\ sin θ \\ cos θ sin ϕ\end{matrix} ]$$

For antenna element n, the position can be represented as

$${d}_{n} = [ \begin{matrix}{d}_{n} cos {δ}_{n} \\ 0 \\ {d}_{n} sin {δ}_{n}\end{matrix} ]$$

where dₙ is the distance from the antenna element to a coordinate origin. Therefore, the steering vector may be represented as

$$\begin{matrix}{a}_{n} ( θ , ϕ ) = {r}^{T} {d}_{n} \\ = {e}^{\frac{π {jd}_{n}}{λ} ( cos ( θ + ϕ - {δ}_{n} ) + cos ( θ - ϕ + {δ}_{n} ) )} \\ = {e}^{\frac{2 π {jd}_{n}}{λ} cos θ cos ( ϕ - {δ}_{n} )}\end{matrix}$$

With Jacobi-Anger Approximation, the steering vector may be represented as:

$$\begin{matrix}{a}_{n} ( θ , ϕ ) = {\sum }_{{k}_{1} = - ∞}^{+ ∞} {j}^{{k}_{1}} {J}_{{k}_{1}} ( \frac{π {d}_{n}}{λ} ) {e}^{{jk}_{1} ( θ + ϕ - {δ}_{n} )} {\sum }_{{k}_{2} = - ∞}^{+ ∞} {j}^{{k}_{2}} {J}_{{k}_{2}} ( \frac{π {d}_{n}}{λ} ) {e}^{j {k}_{2} ( θ - ϕ + {δ}_{n} )} \\ \approx {\sum }_{{k}_{1} = - I}^{+ I} {\sum }_{{k}_{2} = - I}^{+ I} {j}^{( {k}_{1} + {k}_{2} )} {J}_{{k}_{1}} ( \frac{π {d}_{n}}{λ} ) {J}_{{k}_{2}} ( \frac{π {d}_{n}}{λ} ) {e}^{j {k}_{1} ( θ + ϕ ) + j {k}_{2} ( θ - ϕ ) - j ( {k}_{1} - {k}_{2} ) {δ}_{n}}\end{matrix}$$

where Jₖ(⋅) represents a first-class Bezier function of order

$$k , I > \frac{π}{λ} {max}_{n} {r}_{n} ∘$$

furthermore, let θ′=θ+ϕ, ϕ′=θ−ϕ,

$${C}_{n} ( {k}_{1} , {k}_{2} ) = {j}^{( {k}_{1} + {k}_{2} )} {J}_{{k}_{1}} ( \frac{π {d}_{n}}{λ} ) {J}_{{k}_{2}} ( \frac{π {d}_{n}}{λ} ) {e}^{- j ( {k}_{1} - {k}_{2} ) {δ}_{n}}$$

$${{v}_{1} ( {θ}^{′} )}_{{k}_{1}} = {e}^{{jk}_{1} {θ}^{′}}$$

$${{v}_{2} ( {ϕ}^{′} )}_{{k}_{2}} = {e}^{{jk}_{2} {ϕ}^{′}}$$

Then the steering vector can be expressed as:

$${a}_{n} ( θ , ϕ ) \approx {vec ( {C}_{n} )}^{T} ( {v}_{1} ( {ϕ}^{′} ) ⊗ {v}_{2} ( {θ}^{′} ) )$$

where ⊗ represents Kronecker product. vec(A)^{T} is the vectorization of a matrix A which converts the matrix A into a column vector, where vec(Aₙ)^{T} is the nth row of matrix A.

In some embodiments, the CSI-RS is configured as a chirp signal, e.g. CSI-RS for sensing. In such cases the basis matrix may be at least one of a frequency domain basis matrix or spatial domain basis matrix. In a particular example, when the CSI-RS is a chirp signal, the basis matrix in the frequency domain may be based on the following relationship:

$${B}_{freq} = exp ( j 2 π {f}_{i} t + j π α {t}^{2} )$$

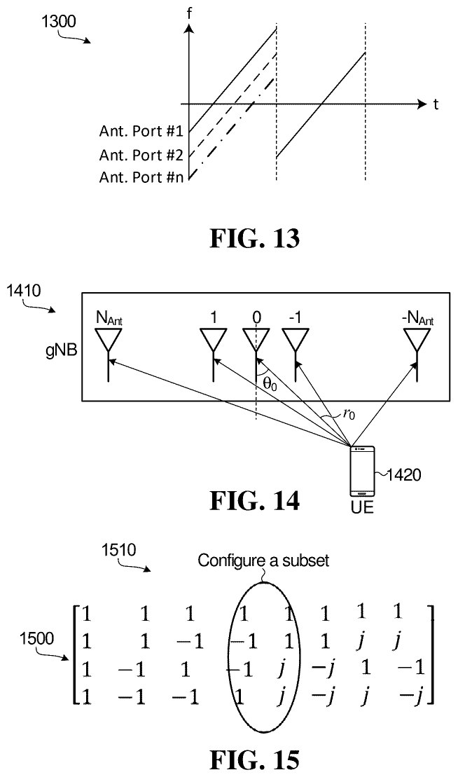

FIG. 13 illustrates an example of a chirp signal 1300 that may be used as a CSI-RS.

In a particular example, when the CSI-RS is a chirp signal, the basis matrix in the spatial domain may be based on the following relationship:

$${b}_{n}^{n − f} = exp \{ − j π ( {θ}_{0} n + \frac{λ ( 1 − {θ}_{0}^{2} )}{4 {r}_{0}} {n}^{2} ) \}$$

where n is an index of an antenna and f is index of a frequency sub-carrier.

FIG. 14 illustrates an example of a receiver, in the form of a UE 1420, in a near field of a 1 dimensional antenna array of a transmitter, in the form of a gNB 1410 or base station. The antenna array includes 2N_{Ant}+1 antennas in the antenna array. FIG. 14 illustrates the variables θ₀ and r₀ with regard to the antenna labeled as “o” in the antenna array.

In some embodiments, a number of projections for the basis matrix for CSI quantization may be a sub-set of the complete orthogonal basis matrix set. FIG. 15 shows an example of a complete orthogonal basis matrix 1500 where only the matrix elements in the circled portion 1510 are configured. A portion may be configured by identifying the matrix elements that are to be configured and what the new configured matrix elements are.

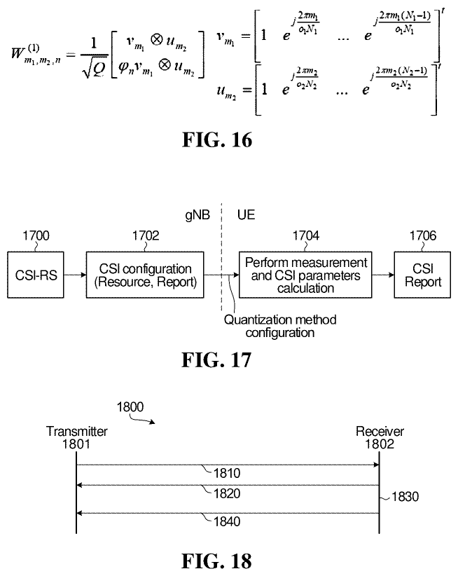

In some embodiments, oversampling of the complete orthogonal basis matrix set may be applied to the basis matrix for CSI quantization. FIG. 16 shows an example of weighting factors that may be applied, where O₁, O₂ are the oversampling factors.

In some embodiments, the transmitter, which may be a base station, sends configuration information that includes vector quantization configuration information to the receiver, which may be a UE.

In some embodiments, the vector quantization configuration information may include an indication of a Quantization objective. In a particular example, this may include that the vector quantization is intended to quantize the top 2 eigen vectors of a channel matrix or tensor that represents the channel in matrix or tensor between the transmitter and receiver.

In some embodiments, the vector quantization configuration information may include information about the basis matrix configuration. For example, the vector quantization configuration information may indicate the basis matrix is a DFT basis matrix in at least one of the spatial or the frequency domain or that the basis matrix is the identify matrix in the time domain. Other basis matrix configuration information may be an oversampling factor, such as an oversampling factor for the spatial domain is Oₛₚₐₜᵢₐₗ=4 or an oversampling factor for the frequency domain is O_{freq}=4.

In some embodiments, the vector quantization configuration information may include information about a threshold for use is selecting channel parameters for feedback to the transmitter. A particular example of a threshold in the spatial domain may be

$$log 10 ( \frac{{C}_{s patiali}}{{C}_{spatialmax}} ) > 10 dB ,$$

where Cₛₚₐₜᵢₐₗᵢ is a value of a spatial domain channel parameter of index i and Cₛₚₐₜᵢₐₗₘₐₓ is a maximum value of a spatial domain channel parameter. A particular example of a threshold in the frequency domain may be frequency domain:

$$log 10 ( \frac{{C}_{freqj}}{{C}_{freqmax}} ) > 15 dB ,$$

where C_{freqj} is a value of a frequency domain channel parameter of index j and C_{freqmax} is a maximum value of a frequency domain channel parameter.

In some embodiments, the vector quantization configuration information may include information about vector quantization accuracy. For example, the vector quantization accuracy may define a number of bits used to represent amplitude and phase of the channel parameters. A particular example of vector quantization accuracy information may be, for parameters in the spatial domain, 3 bits for amplitude and 4 bits for phase. A particular example of vector quantization accuracy information may be, for parameters in the frequency domain, 2 bits for amplitude and 4 bits for phase.

When the receiver receives the vector quantization configuration information, the receiver may be configured to use the provided vector quantization configuration information as part of determining CSI and providing CSI feedback to the transmitter.

As part of the CSI process, the transmitter also sends other configuration information to the receiver, such as configuration information identifying the type of reference signal or other relevant information about the reference signal as well as how and what CSI information should be sent back to the transmitter.

After the receiver has received the configuration information and is aware the reference signal will be sent, the receiver measures the received reference signal and conducts channel estimation based on the reference signal configuration.

The receiver then projects the CSI matrix or tensor to the configured basis matrix to obtain the channel parameters in at least one of the time, spatial or frequency domains.

The receiver performs channel parameter quantization and send feedback information to the transmitter.

FIG. 18 is an example of signal flow diagram 1800 for signaling between a transmitter 1801 and receiver 1802. In some embodiments, the transmitter 1801 may be a base station and the receiver 1802 may be a UE. While the example described below is described for a scenario where the transmitter is a base station and the receiver is a UE, it should be understood that the transmitter is a UE and the receiver is a UE, or the transmitter is a UE and the receiver is a base station.

At step 1810, the transmitter 1801 sends channel state information (CSI) configuration information comprising vector quantization configuration information. The configuration information may also send other configuration information relevant to the receiver 1802 performing a CSI measurement and the receiver 1802 sending CSI information back to the transmitter 1801.

As step 1820, the transmitter 1802 sends a reference signal that the receiver is to use to determine CSI for a channel over which the reference signal is received.

At step 1830, the receiver 1802 measures the received reference signal and determines CSI parameters of the measured reference signal by performing vector quantization based on the vector quantization configuration information received in step 1810.

At step 1840, the receiver sends to the transmitter, the CSI parameters determined in step 1830.

Numerous modifications and variations of the present disclosure are possible in light of the above teachings. It is therefore to be understood that within the scope of the appended claims, the disclosure may be practiced otherwise than as specifically described herein.

1. A method comprising:
for each at least a subset of channel estimates, obtaining a respective quantized channel estimate of quantized channel estimates by quantizing each at least the subset of the channel estimates using scalar quantization, wherein the channel estimates are obtained on channel state information reference symbols (CSI-RSs) transmitted on a plurality of transmit antenna ports; and
transmitting channel state information (CSI) based on the quantized channel estimates.

2. The method of claim 1, further comprising:
performing compression of the quantized channel estimates to produce compressed quantized channel estimates,
wherein the transmitting the CSI comprises transmitting the compressed quantized channel estimates.

3. The method of claim 1, further comprising:
receiving a first signaling; and
when the first signaling indicates to perform the scalar quantization on the channel estimates, performing the obtaining the respective quantized channel estimate and the transmitting the CSI.

4. The method of claim 1, further comprising:
receiving a second signaling; and
when the second signaling indicates to use vector quantization on the channel estimates, transmitting CSI feedback using the vector quantization.

5. The method of claim 1, further comprising:
receiving signaling indicating a quantization accuracy to be applied to all of the channel estimates; and
performing the quantizing using the quantization accuracy.

6. The method of claim 1, further comprising:
receiving signaling indicating a respective quantization accuracy to be applied respective channel estimates; and
performing the quantizing using the respective quantization accuracy.

7. The method of claim 6, wherein each quantization accuracy comprises a first indication of a first number of bits for amplitude and a second indication of a second number for phase.

8. The method of claim 1, further comprising:
selecting the subset of the channel estimates to feedback; and
transmitting an indication of the subset of the channel estimates.

9. The method of claim 8, wherein the selecting the subset of the channel estimates comprises applying a threshold based on a strongest channel estimate.

10. A method comprising:
receiving channel state information (CSI),
wherein the CSI is transmitted based on quantized channel estimates,
wherein, for each at least a subset of channel estimates, a respective quantized channel estimate is obtained by quantizing each at least the subset of the channel estimates using scalar quantization, and
wherein the channel estimates are obtained on CSI reference symbols (CSI-RSs) transmitted on a plurality of transmit antenna ports.

11. An apparatus comprising:
at least one processor; and
a computer readable storage medium, having stored thereon computer executable instructions that, when executed by the at least one processor, cause the apparatus to perform operations including:
for each at least a subset of channel estimates, obtaining a respective quantized channel estimate of quantized channel estimates by quantizing each at least the subset of the channel estimates using scalar quantization, wherein the channel estimates are obtained on channel state information reference symbols (CSI-RS) transmitted on a plurality of transmit antenna ports; and
transmit channel state information (CSI) based on the quantized channel estimates.

12. The apparatus of claim 11, the operations further comprising:
performing compression of the quantized channel estimates to produce compressed quantized channel estimates,
wherein the transmitting the CSI comprises transmitting the compressed quantized channel estimates.

13. The apparatus of claim 11, the operations further comprising:
receiving a first signaling; and
when the first signaling indicates to perform the scalar quantization on the channel estimates, performing the obtaining the respective quantized channel estimate and the transmitting the CSI.

14. The apparatus of claim 11, the operations further comprising:
receive a second signaling; and
when the second signaling indicates to use vector quantization on the channel estimates, transmitting CSI feedback using the vector quantization.

15. The apparatus of claim 11, the operations further comprising:
receive signaling indicating a quantization accuracy to be applied to all channel estimates; and
perform the quantizing using the quantization accuracy.

16. The apparatus of claim 11, the operations further comprising:
receive signaling indicating a respective quantization accuracy to be applied respective channel estimates; and
performing the quantizing using the respective quantization accuracy.

17. The apparatus of claim 16, wherein each quantization accuracy comprises a first indication of a first number of bits for amplitude and a second indication of a second number for phase.

18. The apparatus of claim 11, to the operations further comprising:
selecting the subset of the channel estimates to feedback; and
transmitting an indication of the subset of the channel.

19. The apparatus of claim 18, wherein the selecting the subset of the channel estimates comprises applying a threshold based on a strongest channel estimate.

20. An apparatus comprising:
at least one processor; and
a computer readable storage medium, having stored thereon computer executable instructions that, when executed by the at least one processor, cause the apparatus to perform operations including:
receiving channel state information (CSI),
wherein the CSI is transmitted based on quantized channel estimates,
wherein, for each at least a subset of channel estimates, a respective quantized channel estimate is obtained by quantizing each at least the subset of the channel estimates using scalar quantization,
wherein the channel estimates are obtained on CSI reference symbols (CSI-RSs) transmitted on a plurality of transmit antenna ports.
